(19) United States
(12) Patent Application Publication
(10) Pub. No.: US 2015/0041230 A1
(43) Pub. Date: Feb. 12, 2015

(54) AMUSEMENT VEHICLE, AMUSEMENT ENVIRONMENT FOR A VEHICLE AND METHOD OF USING THE SAME

(71) Applicant: GKart Inc., St-Bruno (CA)

(72) Inventors: Pierre-Luc Lefebvre, St-Bruno (CA); Alexandre Lemire, Laval (CA)

(21) Appl. No.: 14/451,791

(22) Filed: Aug. 5, 2014

Related U.S. Application Data
(60) Provisional application No. 61/864,936, filed on Aug. 12, 2013.

(51) Int. Cl. A63G 33/00; G05D 1/00; A63G 25/00

(52) U.S. Cl. CPC A63G 33/00; A63G 25/00; G05D 1/0022; G05D 1/0027
USPC 180/167

(57) ABSTRACT

The present document describes an amusement vehicle for interacting with at least another amusement vehicle in an amusement environment, the amusement vehicle comprising: a chassis; a set of wheels for rotatably supporting the chassis on a ground surface; a motor mounted on the chassis for propelling the chassis on the ground surface; a controller operably connected to the motor for controlling the motor; and at least one of: a receiver mounted on the chassis for receiving a first directional signal of the at least another amusement vehicle only when the at least another amusement vehicle is in substantial alignment with the receiver; and a transmitter mounted on the chassis for transmitting a second directional signal to one of the at least another amusement vehicle in substantial alignment with the transmitter; the controller being at least one of: operably connected to the receiver and being configured to decode the first signal for controlling the motor in accordance with instructions included in the first signal; and operably connected to the transmitter and being configured to encode the second signal prior to sending it to the at least another amusement vehicle via the transmitter.

### CROSS-REFERENCE TO RELATED APPLICATIONS

This application claims priority under 35USC §119(e) of U.S. provisional patent application No. 61/864,936, filed on Aug. 12, 2013, the specification of which is hereby incorporated by reference.

### BACKGROUND

(a) Field

The subject matter disclosed generally relates to amusement vehicle such as go-karts, bump-karts, amusement boats and the like. More particularly, the subject-matter disclosed relates to amusement vehicles which can interact with other amusement vehicles of a same amusement environment for vehicles and/or with an amusement environment for vehicles.

(b) Related Prior Art

Kart racing or karting is a variant of open-wheel motorsport with small, open, four-wheeled vehicles called karts, go-karts, or gearbox/shifter karts depending on the design. They are usually raced on scaled-down circuits. Karting is commonly perceived as the stepping stone to the higher and more expensive ranks of motorsports.

Kart racing is generally accepted as the most economic form of motorsport available on four wheels. As a free-time activity, it can be performed by almost anybody.

Referring to a study performed by the National Kart News in the United States on customers currently attending go-kart circuits, 52% of participants are between 22 and 35 years old, 25% are between 10 and 21 years old and 23% are over 36 years old. Moreover, 88% of the customers are male and 43% are professionals or self-employed.

What emerge from this study is that there are mainly two categories of people attending go-cart tracks: families looking forward for good time, and young adults who love speed and car racing sports. In addition, the study reports that 92% of professional race car drivers got their start in karting, thus reinforcing the image of the sport competition for young adult clientele.

The go-kart market is about $500 million annually. There is therefore a need for improvements related to go-kart vehicle (or amusement vehicles) and go-kart circuits (or amusement environment for vehicles).

As for example, BattleKart, a company from Belgium, also disclosed a karting game to recreate video games such as Mario Kart (Nintendo™) and Crash TeamRacing (PlayStation™). The system used by BattleKart requires projection on the grounds of a karting track, of virtual “elements” and of real “elements”. Thus, the system proposed by BattleKart allows for interactions between the drivers/players (i.e., between the kart vehicles) and the “elements” (virtual or not) that are projected on the track. The system proposed by Battle Kart is thus based on the projection of the object on the ground, on a localization equipment (such as a GPS) and on a server. This setup for recreating a real-life Mario Kart race or a real-life Crash TeamRacing race would be difficult and expensive to integrate on already established karting tracks around the globe as it would require introducing a complex system (i.e., which includes a screen surrounding the tracks to show the “elements” to the drivers/players and a GPS localization system in communication with a server to identify the position of each one of the drivers/players that are on the track) to existing setups. Additionally, as this system requires the presence of a screen surrounding the track, it would be hardly implementable on outdooring karting recreation centers.

There is therefore a need for improved amusement vehicles and improved amusement environments for vehicles.

### SUMMARY

According to an embodiment, there is provided an amusement vehicle for interacting with at least another amusement vehicle in an amusement environment, the amusement vehicle comprising: a chassis; a set of wheels for rotatably supporting the chassis on a ground surface; a motor mounted on the chassis for propelling the chassis on the ground surface; a controller operably connected to the motor for controlling the motor; and at least one of: a receiver mounted on the chassis for receiving a first directional signal of the at least another amusement vehicle only when the at least another amusement vehicle is in substantial alignment with the receiver; and a transmitter mounted on the chassis for transmitting a second directional signal to one of the at least another amusement vehicle in substantial alignment with the transmitter; the controller being at least one of: operably connected to the receiver and being configured to decode the first signal for controlling the motor in accordance with instructions included in the first signal; and operably connected to the transmitter and being configured to encode the second signal prior to sending it to the at least another amusement vehicle via the transmitter.

According to another embodiment, the amusement vehicle further comprises a signal sensor for receiving a third signal from at least one of: a decelerating interacting element, an accelerating interacting element and a random interacting element position on the ground surface of the amusement environment in substantial alignment with the signal sensor, wherein the controller is being operably connected to the signal sensor and being configured to decode the third signal for controlling the motor in accordance with instructions included in the third signal.

According to a further embodiment, the transmitter is located near a front portion of the chassis and the receiver is located near a rear portion of the chassis.

According to yet another embodiment, at least one of the first signal and the second signal is encoded to cause at least one of: accelerating the amusement vehicle, accelerating the at least another amusement vehicle, decelerating the amusement vehicle, decelerating the at least another amusement vehicle, stopping the at least another vehicle and side-slipping the at least another vehicle.

According to another embodiment, the transmitter and the receiver respectively comprises a wireless transmitter and a wireless receiver.

According to a further embodiment, the wireless transmitter and the wireless receiver respectively transmit a directional signal selected from the group consisting of: infra-red and laser, or any combination thereof.

According to yet another embodiment, the amusement vehicle further comprises at least one of: a user interface mounted on the chassis and operably connected to the controller for controlling the amusement vehicle and communication with the at least another amusement vehicle; an indicator mounted on the chassis and operably connected to the controller for indicating to a driver of the amusement vehicle information about the first and second signals; a speaker mounted on the chassis and operably connected to the controller for providing the driver of the amusement vehicle a sonar indication; and a push button mounted on the chassis and operably connected to the controller for allowing the driver of the amusement vehicle to transmit the second signal to the at least another amusement vehicle.

According to another embodiment, the indicator comprises at least one of: a light indicator, a sound indicator and a vibration indicator.

According to a further embodiment, the amusement vehicle further comprises a speed controller mounted on the chassis and operably connected to the controller for controlling the speed of the vehicle in accordance with the instructions included in the first signal.

According to yet another embodiment, the amusement vehicle further comprises a communication system operatively connected to the controller for allowing a circuit operator to manage at least one of: the amusement environment and interactions between the amusement vehicle and the at least another amusement vehicle.

According to another embodiment, there is provided a kit for installing on an amusement vehicle having a chassis, a set of wheels and a motor the amusement vehicle for interacting with at least another amusement vehicle in an amusement environment, the kit comprising: at least one of: a receiver to be mounted on the chassis for receiving a first directional signal from the at least another amusement vehicle only when the at least another amusement vehicle is in substantial alignment with the receiver; and a transmitter to be mounted on the chassis for transmitting a second directional signal to one of the at least another amusement vehicle in substantial alignment with the transmitter; and a controller to be mounted on the chassis and to be at least one of: operably connected to the receiver and to be configured to decode the first signal for controlling the motor in accordance with instructions included in the first signal; and operably connected to the transmitter and to be configured to encode the second signal prior to sending it to the at least another amusement vehicle via the transmitter.

According to a further embodiment, the kit further comprises at least one of a decelerating interacting element, an accelerating interacting element and a random interacting element to be positioned on the ground surface of the amusement environment.

According to yet another embodiment, the kit further comprises a signal sensor for receiving a third signal from the at least one of: the decelerating interacting element, the accelerating interacting element and the random interacting element positioned on the ground surface of the amusement environment in substantial alignment with the signal sensor, wherein the controller is to be operably connected to the signal sensor and configured to decode the third signal for controlling the motor in accordance with instructions included in the third signal.

According to another embodiment, at least one of the first signal and the second signal comprises at least one of: accelerating the amusement vehicle, accelerating the at least another amusement vehicle, decelerating the amusement vehicle, decelerating the at least another amusement vehicle, stopping the at least another vehicle and side-slipping the at least another vehicle.

According to another embodiment, the transmitter and the receiver respectively comprises a wireless transmitter and a wireless receiver.

According to a further embodiment, the wireless transmitter and the wireless receiver respectively transmit and receive at least one of: infra-red signals and radio-frequency identification signals.

According to yet another embodiment, the kit further comprises at least one of: a user interface to be mounted on the chassis and operably connected to the controller for controlling the amusement vehicle and communication with the at least another amusement vehicle; an indicator to be mounted on the chassis and operably connected to the controller for indicating to a driver of the amusement vehicle information about the first and second signals; a speaker to be mounted on the chassis and operably connected to the controller for providing the driver of the amusement vehicle a sonar indication; and a push button to be mounted on the chassis and operably connected to the controller for allowing the driver of the amusement vehicle to transmit the second signal to the at least another amusement vehicle.

According to another embodiment, the kit further comprises a speed controller to be mounted on the chassis and operably connected to the controller for controlling the speed of the vehicle in accordance with the instructions included in the first signal.

According to a further embodiment, the kit further comprises a communication system to be operatively connected to the controller for allowing a circuit operator to manage at least one of: the amusement environment and interactions between the amusement vehicle and the at least another amusement vehicle.

According to another embodiment, there is provided an amusement vehicle for interacting with at least another amusement vehicle in an amusement environment, the amusement vehicle comprising: a chassis; a set of wheels for rotatably supporting the chassis on a ground surface; a motor mounted on the chassis for propelling the chassis on the ground surface; a controller operably connected to the motor for controlling the motor; and a receiver located near a rear portion of the chassis for receiving a first wireless signal of the at least another amusement vehicle only when the at least another amusement vehicle is in substantial alignment with the receiver; and a transmitter located near a front portion of the chassis for transmitting a second directional signal to one of the at least another amusement vehicle only when the at least another amusement vehicle is in substantial alignment with the transmitter; the controller being at least one of: operably connected to the receiver and being configured to decode the first signal for controlling the motor in accordance with instructions included in the first signal; and operably connected to the transmitter and being configured to encode the second signal prior to sending it to the at least another amusement vehicle via the transmitter; wherein the first signal and the second signal are directional signals and require substantial alignment between the amusement vehicles to be received.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates an amusement circuit of an amusement environment in accordance with an embodiment;

FIG. 2 is a closed-up view of two amusement vehicles of FIG. 1;

FIG. 3 illustrates an amusement vehicle in accordance with another embodiment;

FIG. 4 illustrates an amusement vehicle in accordance with another embodiment;

FIG. 5 is a top perspective view of an amusement vehicle in accordance with another embodiment;

FIG. 6 is a top perspective view of a controller in accordance with another embodiment;

FIG. 7 is a perspective view of a transmitter in accordance with another embodiment;

FIG. 8. is a top perspective view of a speed controller in accordance with another embodiment;

FIG. 9 is a rear elevation view of an amusement vehicle in accordance with another embodiment, showing a receiver;

FIG. 10 is a top perspective view of a speed sensor in accordance with another embodiment; and

FIG. 11 is a top perspective view of a signal sensor in accordance with another embodiment.

It will be noted that throughout the appended drawings, like features are identified by like reference numerals.

### DETAILED DESCRIPTION

In embodiments, there are disclosed amusement vehicles, amusement environments for amusement vehicles and methods of using the same.

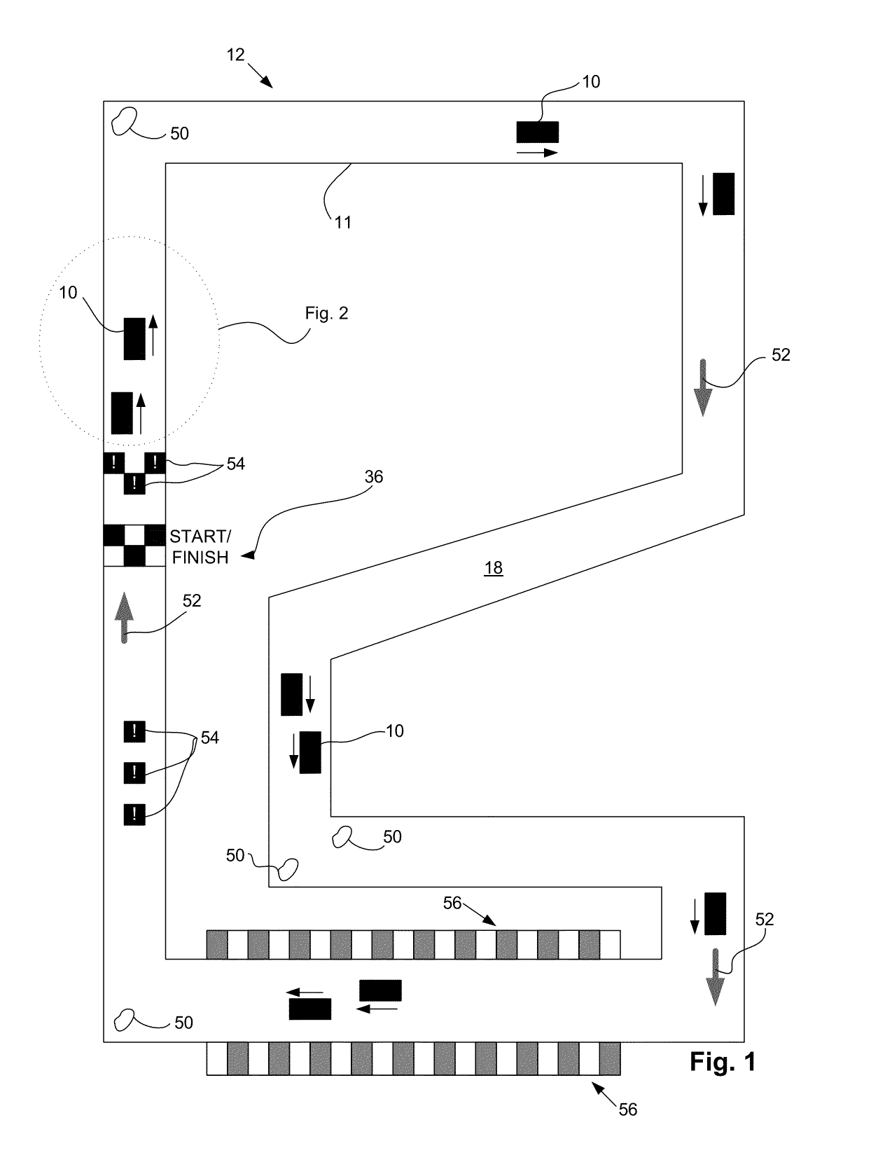

Referring now to the drawings, and more particularly to FIG. 1, there is shown an amusement environment 12 in accordance with an embodiment. The environment 12 (hereinbelow referred to as environment 12) allows one or a plurality of amusement vehicles 10 (hereinbelow referred to as vehicles 10) to circulate within an amusement circuit 11 and to interact with one or more other vehicles 10. The environment 12 further allows one or a plurality of vehicles 10 to circulate within the amusement circuit 11 and to interact with interacting elements such as, without limitation, decelerating interacting elements 50, 56, accelerating interacting elements 52 and random interacting elements 54, as described in more detail below. As for example, the vehicle 10 may be, without limitation, a go-kart, a bump-kart, a two-wheeler, a three-wheeler, a four-wheeler, an amusement boat, a mountain bike, a bike of an amusement center and the like.

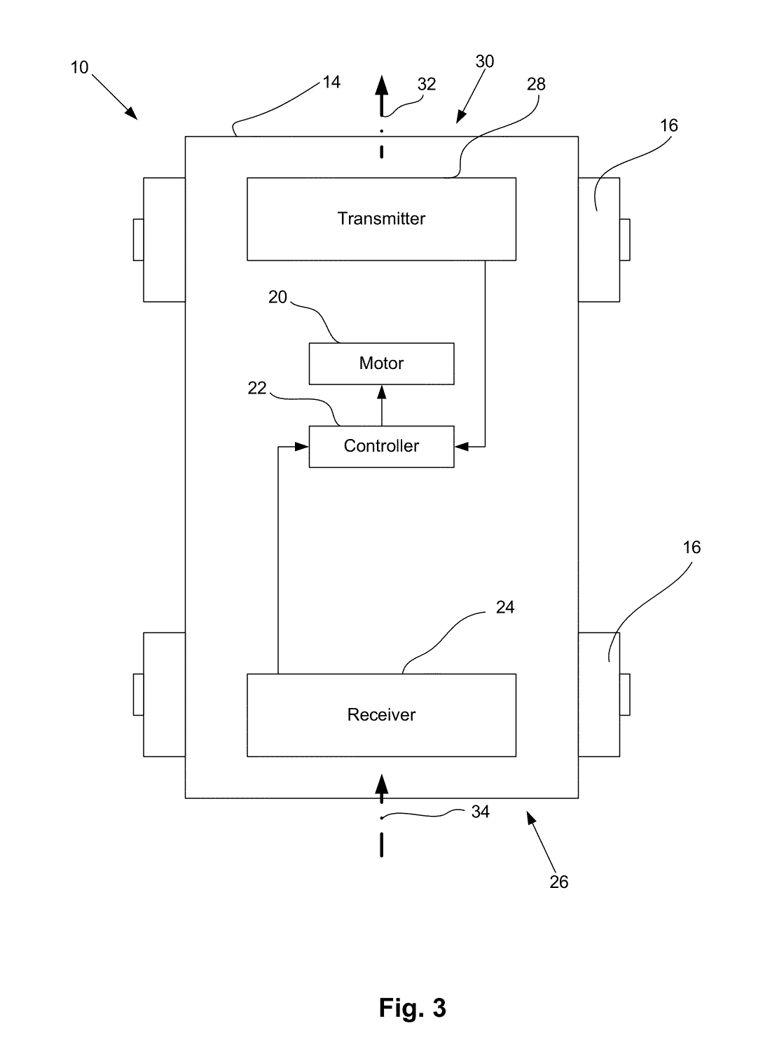

Referring now to FIG. 3 and according to another embodiment, there is shown a vehicle 10. The vehicle 10 is for interacting with one or more other vehicle(s) 10 which circulate in the circuit 11 of the environment 12. As schematically shown, the vehicle 10 includes a chassis 14 and a set of wheels 16 which rotatably supports the chassis 14 on a ground surface 18 (FIG. 1). The vehicle 10 further includes a motor 20 mounted on the chassis 14 for propelling the chassis 14 on the ground surface 18 and a controller 22 which is operably connected to the motor 20 for controlling the motor 20. The vehicle 10 of FIG. 3 further includes a receiver 24 and a transmitter 28. The receiver 24 is mounted on the chassis 14 for receiving one or more signals 34 from the transmitter 28 of one or more other vehicles 10. On the other hand, the transmitter 28 is mounted on the chassis 14 for transmitting one or more signals 32 to one or more other vehicles 10 through their receivers 24. It is to be noted that the vehicle 10 may include the receiver 24 only, the transmitter 28 only or both the receiver 24 and the transmitter 28. For example, a vehicle 10 that would include only a receiver 24 would only be able to receive one or more receiving signals 34 from one or more other vehicles 10. On the other hand, a vehicle 10 that would include only a transmitter 28 would only be able to transmit one or more transmitting signals 32 to one or more other vehicles 10.

As shown in FIG. 3, the transmitter 28 may be located near a front portion 30 of the chassis 14 of the vehicle 10, while the receiver 24 may be located near a rear portion 26 of the chassis 14 of the vehicle 10. However, it is to be noted that the transmitter 28 and the receiver 24 may be located at any position on the chassis 14, such as to allow a driver of a first vehicle 10 to transmit a transmitting signal 32 towards a receiver 24 of a second vehicle 10. For example, the transmitter 28 and/or the receiver 24 may be located on one or both of the sides of the chassis 14, or the transmitter 28 may be located in the rear portion 26 of the chassis 14 while the receiver 24 may be located in the front portion 30 of the chassis 14.

In an embodiment, the concept of “powers” (or privileges) may be embedded into the vehicles 10 as in the traditional video games, whereby, the user at the beginning of the game may have a given amount of powers (or none), and the powers may be lost or gained throughout the game in accordance with the performance. The powers may be used to perform one or more of the following: accelerating own vehicle 10, decelerating own vehicle 10 and/or other vehicles 10, stop other vehicles 10, decelerate all other vehicles 10, cause an accident etc. In the present scenario, the transmitter 28 and the receiver 24 may be used for transmitting and/or receiving powers from or to another vehicle 10, or from an interacting element 50, 52, 54 or 56 (decelerating interacting elements 50, 56, accelerating interacting elements 52 or random interacting elements 54).

According to another embodiment, the transmitter 28 may be a wireless transmitter 28. The transmitter 28 may transmit, without limitation, infra-red signals, radio-frequency identification signals (i.e., RFID signals) and any other suitable wireless signals which may be read by a receiver 24 of another vehicle 10. The receiver 24 may be configured such as to receive the signals emitted from the transmitter 28.

According to an embodiment, the transmitter 28 of the vehicle 10 may include an infra-red transmitter (i.e., an infra-red cannon) for transmitting signals 32 to another vehicle 10.

In operation, the controller 22 of the vehicle 10, decodes the signal 34 received from another vehicle 10 to execute the instructions included in the signal 34. As discussed above, the instructions may be for accelerating the vehicle 10, decelerating the vehicle 10, adding powers from a teammate vehicle (e.g. a teammate may send powers to each other on the signal 32), and implement various other functions.

On the other hand, if the user intends to send a signal 34 to another vehicle 10 ahead/behind of them, the user may choose the function that he wants the other vehicle to implement and send it via the transmitter 28. In the present case, the encoder may embed the function into the signal 34 and send the signal 34 via the transmitter 28 to the other vehicle 10.

Although FIG. 3 shows the vehicle 10 as including one receiver 24 and one transmitter 28, it is also possible to implement the vehicle such that it includes only the transmitter 28 (i.e., without receiver 24), whereby the user of such vehicle may only transmit to other vehicles 10 without receiving signals from them.

In another embodiment, the vehicle 10 may include only the receiver 24 (i.e., without transmitter 28) whereby the user of such vehicle 10 may only receive signals 34 from others without sending.

In a further embodiment, the vehicle 10 may further include a plurality of receivers 24 for receiving a plurality of signals 34 and/or a plurality of transmitters 28 for transmitting a plurality of signals 32. In the present scenario, the receivers 24 and/or transmitters 28 may be provided in various locations on the chassis 14 such as, but not limited to, the front, sides and the back of the vehicle 10.

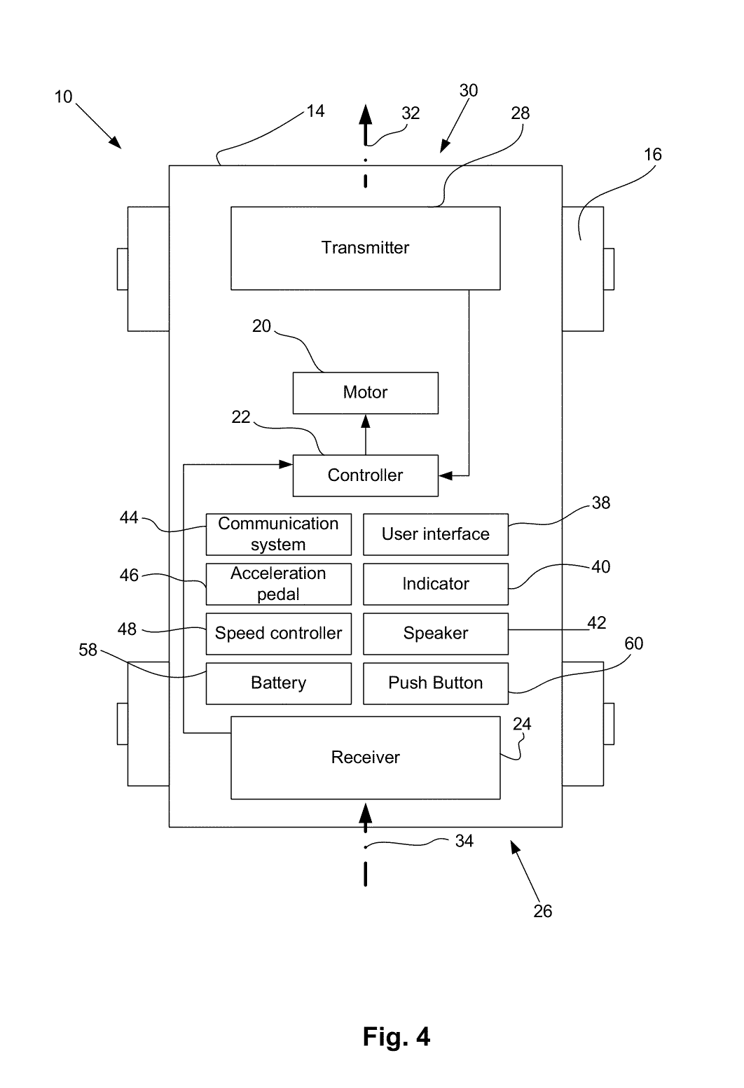

According to another embodiment and referring now to FIG. 4, the vehicle 10 may further include a user interface 38 mounted on the chassis 14 and operatively connected to the controller 22. The user interface 38 may be used for controlling the vehicle and for controlling the communication with the other vehicles 10.

According to another embodiment and still referring to FIG. 4, the vehicle 10 may further include one or more indicator(s) 40 mounted on the chassis 14 and used as a power indicator to inform the driver of their remaining powers and/or of the powers that have been lost. The indicator 40 may be, without limitation, a light indicator, a sound indicator, a vibration indicator, and the like. For example, the user interface 38 may include a visual indicator for indicating the powers that were originally available, the powers that were lost, the powers that were gained, the powers that were sent/used, the powers that were received, etc.

The indicator 40 may be provided in the user interface 38 or on the steering wheel of the vehicle.

In another embodiment, the indicator 40 may also indicate the function associated with the available powers such as: available powers to accelerate his own vehicle 10, available powers to decelerate other vehicles 10, etc.

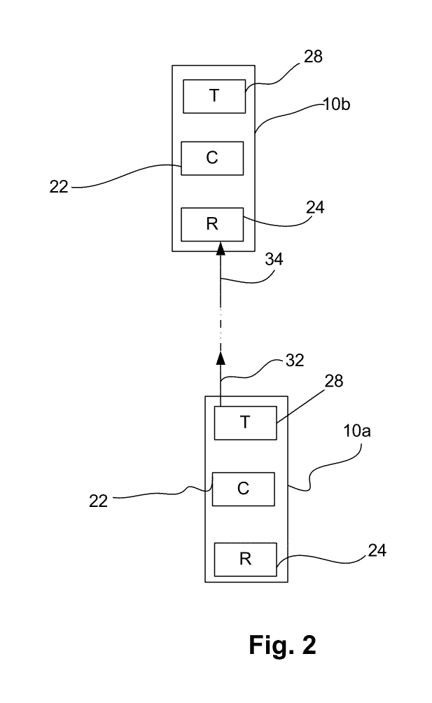

In a preferred embodiment and referring now to FIG. 2, the transmitters may be adapted to transmit a directional signal to the other vehicle such as the infrared or laser and the like. To be received by the other vehicle a substantial alignment between the two vehicles 10 must exist. Directional signals are the preferred communication means between the different amusement vehicles due to the added challenge of aligning the vehicles before transmitting the signal. By contrast, wireless signals that propagate in a non-directional way are not preferred for use in the present embodiments because they render the game less challenging and imprecise because the signal may be received by another vehicle other than the one that was intended to receive it. In the present case, the driver may decelerate a friend rather than an opponent and vice versa. This scenario is also preferred from the standpoint of installation because it is easier to install the receiver and transmitter at the front and rear portions of the car instead of modifying the physical track/environment in which the game/race is practiced for installing cameras, location detectors (GPS) and projectors, as in the prior art. In the present case, the indicator 40 (FIG. 4) may be configured to alert a driver (i.e., emit a sound, a light and the like) of the substantial alignment of his vehicle 10a with the other vehicle 10b to which they intend to send the signal 32. For example, when a first driver of a first vehicle 10a tries to transmit a decelerating power to decelerate a second driver in a second vehicle 10b, the sonar indicator will emit a predetermined sound to indicate to the first driver in vehicle 10a if he is near or far of reaching the receiver 24 of the second vehicle 10b. On the other hand, the sonar indicator of the second vehicle 10b will emit another predetermined sound to indicate to the second driver that the first driver is trying to reach his receiver 24 with his signal 32 (i.e., decelerating power). It is to be noted that any suitable light and/or sound indication may be used to inform a driver of a vehicle 10 that he is transmitting and/or receiving signals 32, 34 (i.e., powers).

For example, when the first driver of vehicle 10a (which is following the second driver of vehicle 10b) is near to reach the second driver of vehicle 10b with his decelerating power, the sonar indicator may accelerate in a way such as to inform the first and/or the second driver(s) that the power (i.e., decelerating power) is near to be transmitted to the second driver. In this case, the second driver may hear a different sound from his sonar indicator, and will try to escape from the first driver (i.e., the second driver does not want to receive the decelerating power). Thus, a slow sound indication indicates to the first driver that the receiver 24 of the second vehicle 10b can be reached, while a faster sound indication indicates to the first driver that the receiver 24 of the second vehicle 10b is almost reached or is very close to be reached. Thus, the distance between the transmitter 28 of the first vehicle 10a and the second vehicle 10b is important to transmit and receive signals 32, 34. The angle as well as the distance and alignment between the transmitter 28 of the first vehicle 10a and the second vehicle 10b may also be important to transmit and receive signals 32, 34.

According to another embodiment, and referring to FIG. 4, a speaker 42 may be mounted on the chassis 14 of the vehicle 10 to provide the driver of the vehicle 10 to hear the sonar indication. It is to be noted that the speaker 42 may be integrated to the chassis 14 of the vehicle 10.

According to another embodiment and still referring to FIG. 4, the vehicle 10 may further include one or more push button 60 or remote operatively connected to the controller 22 to allow the driver of a vehicle 10 to transmit signals 32 to one or a plurality of other vehicle(s) 10.

According to another embodiment and still referring to FIG. 4, there is shown that the vehicle 10 further includes an acceleration pedal 46 and a speed controller 48 which are each operatively connected to the controller 22 for controlling the speed of the vehicle 10. Thus, when the vehicle 10 receives or uses its acceleration power, the speed controller 48 allows the vehicle 10 to go faster (i.e., instead of simultaneously accelerating the vehicle 10). The driver then has the possibility, if he wishes to do so, to accelerate on the circuit 11 and to overtake the other vehicles 10. On the other hand, when the vehicle 10 receives a deceleration power, the speed controller 48 allows the vehicle 10 to reduce its speed (i.e., instead of simultaneously decelerating the vehicle 10). The competitors then have the possibility to overtake the vehicles 10 which are required to decelerate. The speed controller 48 then allows accelerating and decelerating actions which are safe on the circuit 11.

According to another embodiment, the vehicle 10 may further include a battery 58 to operate at least one of, without limitation, the transmitter 28, the controller 22, the receiver 24, the speed controller 48, the user interface 38, and the like.

According to a further embodiment, there is provided a kit for installing on a vehicle 10 which has a chassis 14, a set of wheels 16 and a motor 20. As described above, the vehicle 10 is for interacting with one or more other vehicles 10 of an environment 12 for vehicles 10. The kit includes a receiver 24 which is to be mounted on the chassis 14 of the vehicle 10 for receiving a signal 34 from the one or more other vehicles 10 and/or a transmitter 28 which is to be mounted on the chassis 14 of the vehicle 10 for transmitting a signal 32 to the one or more other vehicles 10. The kit may further include a controller 22 which is to be operably connected to the motor 20 of the vehicle 10 for controlling the motor 20. Once connected to the motor 20 of the vehicle 10, the controller 22 decodes and/or encodes the receiving signal 34 and/or the transmitting signal 32 and implements instructions for accelerating and/or decelerating the chassis 14 and/or the one or more vehicles 10 of the environment 12.

According to another embodiment, the receiver 24 may be installed on the rear portion 26 of the chassis 14 of the vehicle 10 while the transmitter 28 may be installed on the front portion 30 of the vehicle 10.

According to another embodiment, the controller 22 may be mounted on a steering wheel (not shown) which is to replace an existing steering wheel or the controller 22 may be mounted on an existing steering wheel. It is to be noted that the controller 22 may also be mounted on a piece of equipment which is to be introduced and/or mounted on the chassis 14 of the vehicle 10. The controller 22 may also control other electronic devices within the vehicle 10 such as, without limitation, the transmitter 28, the receiver 24, the pedal brake (not shown), the acceleration pedal 46, lights (not shown), speakers 42, and the like. It is to be noted that the indicator 40, the speaker 42 and/or the user interface 38 may be integrated within the steering wheel.

In accordance with another embodiment, the amusements vehicle(s) 10 and the amusement environment 12 may be utilized for playing a go-kart game or a go-kart race. The go-kart game/race requires one or a plurality of vehicle(s) 10 to travel on the circuit 11. If there is a plurality of vehicles 10 on the circuit 11, the drivers of the plurality of vehicles 10 may form a team or may play the game by themselves. The driver or the drivers may ride the circuit 11 during a certain amount of time or for a predetermined number of laps. The drivers may start a race at the start/finish line 36 (FIG. 1). The drivers may need to recuperate a certain amount of powers or they may be given a number of predetermined powers taken from, without limitations, decelerating interacting elements 50, 56, accelerating interacting elements 52, stopping interacting elements, side-slipping interacting elements and/or other random interacting elements 54. Once the race starts, the drivers, in their vehicles 10, may transmit a signal 32 to another vehicle 10 driven by another driver (FIG. 2). A driver may decide to transmit a signal 32 which will decelerate the vehicle 10 of a competitor. However, the driver may also decide to transmit a signal 32 which will accelerate the vehicle 10 of a team mate driver. The driver of the vehicle 10 may also transmit a signal 32 which will stop completely the vehicle 10 of a competitor. The driver of the vehicle 10 may further transmit a signal 32 which will make the vehicle 10 of a competitor side-slip down the ground surface 18 of the circuit 11. A driver may also receive a signal 34 from a competitor which will decelerate his vehicle 10. However, the driver may also receive a signal 34 from a team mate driver which will accelerate his vehicle 10. The driver of the vehicle 10 may also receive a signal 34 from a competitor which will stop completely his vehicle 10. The driver of the vehicle 10 may further receive a signal 34 from a competitor which will make his vehicle 10 side-slips down the ground surface 18 of the circuit 11.

According to another embodiment, the interacting elements (decelerating interacting elements 50, 56, accelerating interacting elements 52 and random interacting elements 54) may include proximity sensors such as magnetic interacting elements such as to be transmitted to the receiver 24 of a vehicle 10. Thus, the receiver 24 of a vehicle 10 may further include a magnetic signal receiver such as to receive magnetic signals from the interacting elements. For example, the magnetic signal receiver may be located under the chassis of the vehicle 10 such as to receive the magnetic signal when the vehicle 10 circulates on a proximity sensor of an interacting element 50, 52, 54 or 56.

According to another embodiment, the vehicle 10 may further include a GPS (not shown) for allowing an operator of the environment 12 to be informed of the position in time of one or a plurality of vehicles 10.

In accordance with a further embodiment, after completing one lap, a driver may position his vehicle 10 such as to receive additional powers by receiving signals 34 taken from the random interacting elements 54 positioned on the ground surface 18 of the circuit 11. On the other hand, at any time or position when completing a lap, a driver may position his vehicle 10 such as to receive additional powers and/or such as to lose gained powers by receiving signals 34 taken from the random interacting elements 54, the decelerating interacting elements 50, the accelerating interacting elements 52 and/or the decelerating interacting elements 56. For example, if a receiver 24 of a vehicle 10 circulates aligned on a random interacting element 54, the vehicle 10 may receive signals 34 on an arbitrary manner, and the controller 22 would decode and implement instructions for accelerating, decelerating, side-slipping and/or stopping his vehicle 10 and/or another vehicle 10. If a receiver 24 of a vehicle 10 circulates aligned on a decelerating interacting element 50, the vehicle 10 may receive signals 34, and the controller 22 would decode and implement instructions for decelerating his vehicle 10 and/or another vehicle 10 (i.e., in the case where all the drivers from a same team would decelerate at the same time during a race). If a receiver 24 of a vehicle 10 circulates aligned on an accelerating interacting element 52, the vehicle 10 may receive signals 34, and the controller 22 would decode and implement instructions for accelerating his vehicle 10 and/or another vehicle 10 (i.e., in the case where it would be possible for all the drivers from a same team to accelerate at the same time during a race). If a receiver 24 of a vehicle 10 circulates aligned on a decelerating interacting element 56 placed along the borders of the circuit 11 for example, the vehicle 10 may receive signals 34, and the controller 22 would decode and implement instructions for decelerating and/or stopping his vehicle and/or another vehicle 10 (i.e., in the case where all the drivers from a same team would decelerate at the same time during a race). Thus, the driver of a vehicle 10 is capable of controlling his and/or one or more other vehicle 10.

It is to be noted that when a driver has powers, he may use them whenever his best for him to use them for his vehicle 10, or for another vehicle 10 (i.e., of a vehicle 10 which would be in his team or in an adverse team).

According to another embodiment and referring to FIG. 4, the vehicle 10 may further include a communication system 44 operatively connected to the controller 22 for allowing a circuit operator to manage the game between the vehicles 10. Thus, the communication system 44 may be a wireless communication (i.e., such as a radio-frequency communication) system for allowing the circuit operator to be informed about the position of the vehicles 10 on the circuit 11, their speeds, their powers, and the like. Thus, the circuit operator may manage the beginning of the game or race, the end of the game or race, the power attribution, to control of audacious competitors, and the like at a distance from the circuit 11. The wireless communication system 44 may further allow timing a driver or a plurality of drivers performing a race on the circuit 11. The wireless communication system 44 may, without limitation, reconfigure flexible parameters of a game at distance by an operator, start the game at distance, from the operator position, control the speed of drivers on the circuit 11, stop vehicle 10 on the circuit 11 (i.e., to penalize too audacious drivers), to attribute additional powers to drivers that are to lose the game, to give the energy indicator of the battery 58 of the vehicles, to generate and centralize the timing results of the race, and the like.

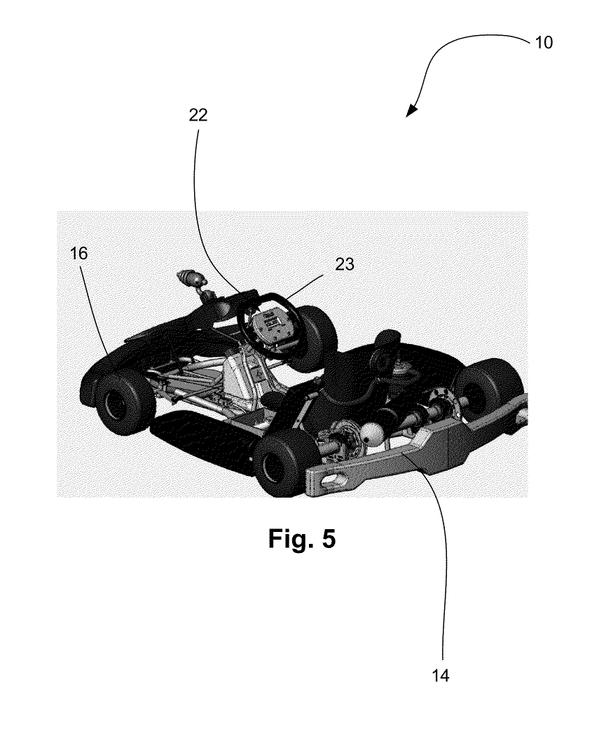

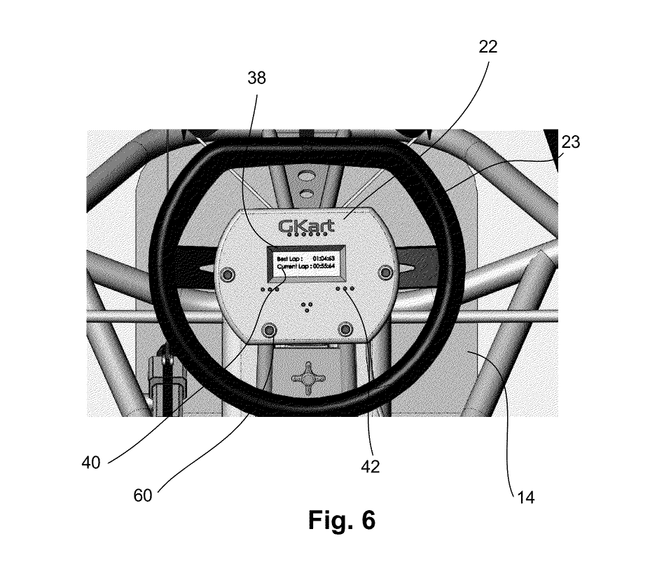

Referring now to FIGS. 5 and 6, there are shown respectively an amusement vehicle 10 in accordance with an embodiment and the controller 22 mounted on a steering wheel 23 of the amusement vehicle 10. As shown, the controller 22 is further in operable communication with a user interface 38 as described above and which includes one or more indicators 40. The controller 22 is further in operable communication with a speaker 42 and push buttons 60 as described above.

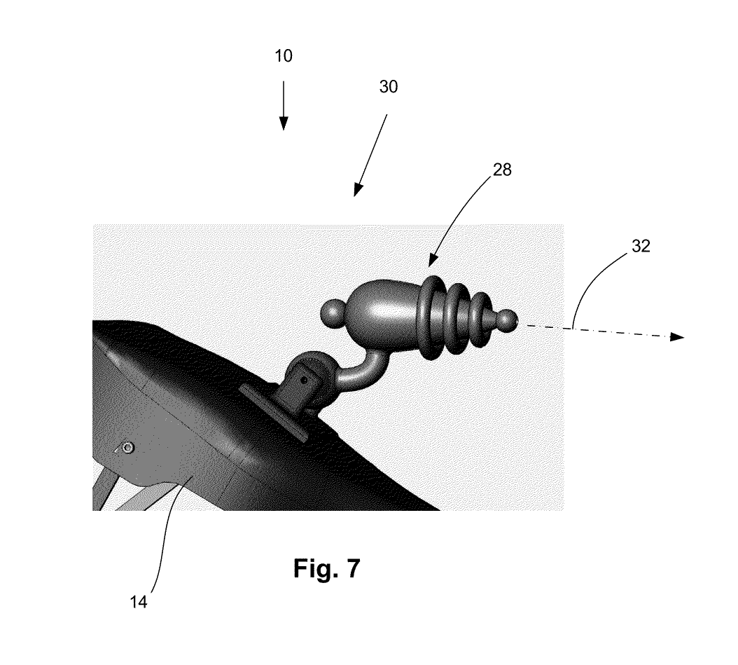

According to one embodiment and referring now to FIG. 7, there is shown a transmitter 28. According to this embodiment, the transmitter 28 is a wireless transmitter 28, but more particularly an infra-red transmitter or an infra-red cannon for transmitting signals 32 to another vehicle 10. The transmitter 28 is mounted near the front portion 30 of the vehicle 10. As mentioned, transmission of a signal 32 to another vehicle 10 requires a substantial alignment between the two vehicles 10 especially in the case of a directional signal such as the infrared.

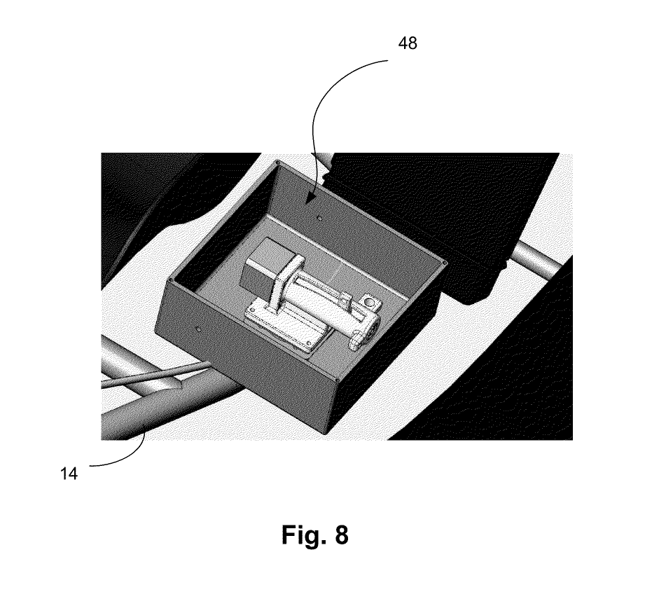

According to one embodiment and referring now to FIG. 8, there is shown a speed controller 48 mounted on the chassis 14 of the vehicle 10. Thus, when the vehicle 10 receives or uses its acceleration power, the speed controller 48 allows the vehicle 10 to go faster (i.e., instead of simultaneously accelerating the vehicle 10). The driver then has the possibility, if he wishes to do so, to accelerate on the circuit 11 and to overtake the other vehicles 10. On the other hand, when the vehicle 10 receives a deceleration power, the speed controller 48 allows the vehicle 10 to reduce its speed (i.e., instead of simultaneously decelerating the vehicle 10). The competitors then have the possibility to overtake the vehicles 10 which are required to decelerate. The speed controller 48 then allows accelerating and decelerating actions which are safe on the circuit 11.

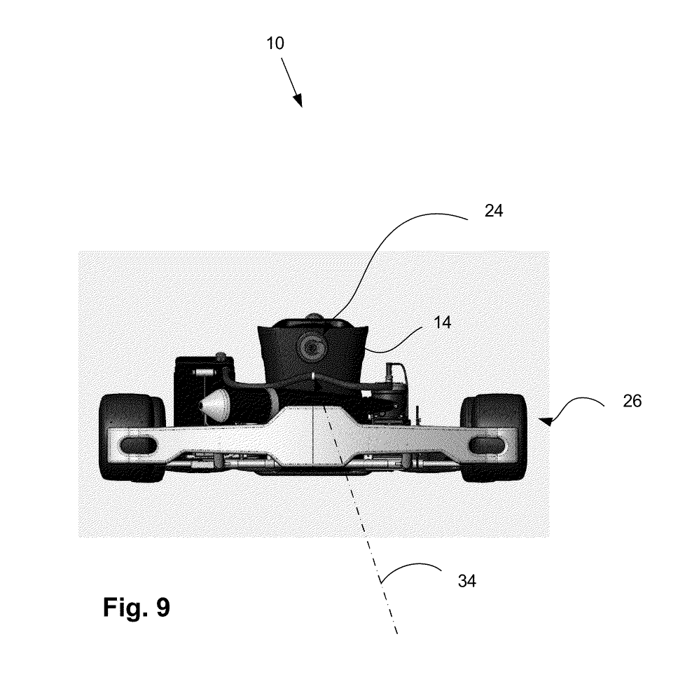

According to one embodiment and referring now to FIG. 9, there is shown a rear view of an amusement vehicle, showing a receiver 24 (or target 24). According to this embodiment, the receiver 24 is a wireless receiver 24, but more particularly an infra-red receiver for receiving signals 34 from another vehicle 10. The receiver 24 is mounted near the rear portion 26 of the vehicle 10. As mentioned, reception of a signal 34 from another vehicle 10 requires a substantial alignment between the two vehicles 10 especially in the case of a directional signal such as the infrared.

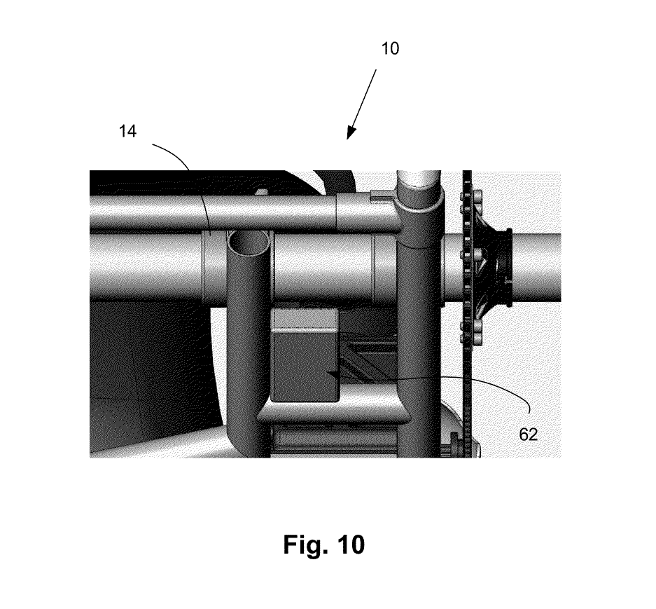

FIG. 10 is a top perspective view of a speed sensor 62 in accordance with another embodiment. The speed sensor 62 is operatively connected to the speed controller 48. One of the purpose of the speed sensor 62 is to ensure that all vehicles are at the same speed during the game/race.

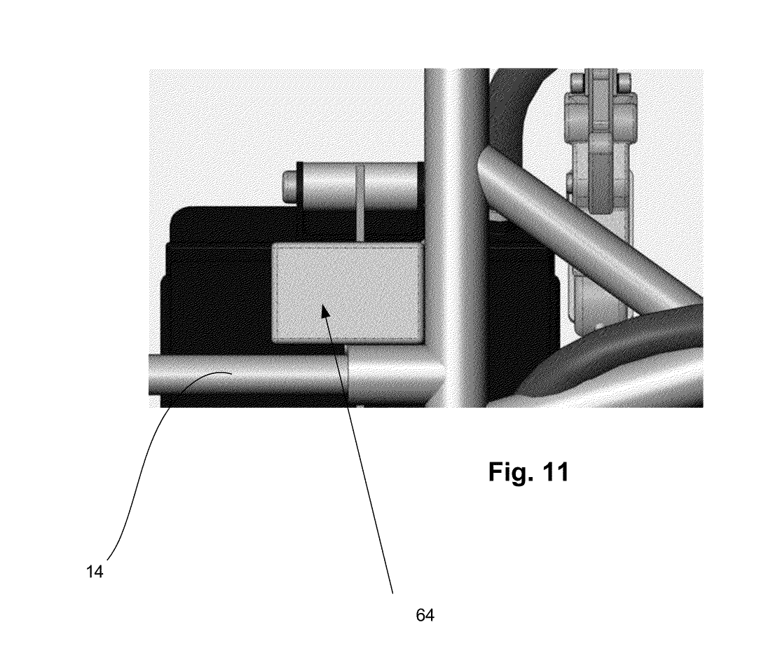

Referring now to FIG. 11 and according to an embodiment, there is shown a signal sensor 64. As described above, the interacting elements (decelerating interacting elements 50, 56, accelerating interacting elements 52 and random interacting elements 54) may include proximity sensors such as magnetic interacting elements such as to be transmitted to the signal sensor 64 which mounted underneath the chassis 14 on FIG. 11. Thus, the signal sensor 64 of a vehicle 10 may further include a magnetic signal receiver such as to receive magnetic signals from the interacting elements. For example, the magnetic signal receiver may be located under the chassis of the vehicle 10 such as to receive the magnetic signal when the vehicle 10 circulates on a proximity sensor of an interacting element 50, 52, 54 or 56.

The amusement vehicle 10 and the amusement environment 12, which includes the circuit 11, the decelerating interacting elements 50, 56, the accelerating interacting elements 52 and the random interacting elements 54, provide a driver to live an amusement experience since the driver may play a game or perform a race while driving the vehicle 10 within the circuit 11 alone or with one or a plurality of other drivers. The vehicle 10 and the environment 12 may allow the driver to create a plurality of overtakes and to have more fun compared to a standard race in a standard vehicle (i.e., go-kart vehicle, bump-kart, two-wheeler, three-wheeler, four-wheeler, amusement boat, mountain bike, bike of an amusement center and the like).

The vehicle 10 and the environment 12, which includes the circuit 11, may give other functionalities to existent vehicle and environment.

The vehicle 10 and the environment 12 allow the re-creation of the universe of a real life video game on an existing go-kart circuit.

While preferred embodiments have been described above and illustrated in the accompanying drawings, it will be evident to those skilled in the art that modifications may be made without departing from this disclosure. Such modifications are considered as possible variants comprised in the scope of the disclosure.

1. An amusement vehicle for interacting with at least another amusement vehicle in an amusement environment, the amusement vehicle comprising:
a chassis;
a set of wheels for rotatably supporting the chassis on a ground surface;
a motor mounted on the chassis for propelling the chassis on the ground surface;
a controller operably connected to the motor for controlling the motor; and
at least one of:
a receiver mounted on the chassis for receiving a first directional signal of the at least another amusement vehicle only when the at least another amusement vehicle is in substantial alignment with the receiver; and
a transmitter mounted on the chassis for transmitting a second directional signal to one of the at least another amusement vehicle in substantial alignment with the transmitter;
the controller being at least one of: operably connected to the receiver and being configured to decode the first signal for controlling the motor in accordance with instructions included in the first signal; and operably connected to the transmitter and being configured to encode the second signal prior to sending it to the at least another amusement vehicle via the transmitter.

2. The amusement vehicle of claim 1, further comprising a signal sensor for receiving a third signal from at least one of: a decelerating interacting element, an accelerating interacting element and a random interacting element position on the ground surface of the amusement environment in substantial alignment with the signal sensor, wherein the controller is being operably connected to the signal sensor and being configured to decode the third signal for controlling the motor in accordance with instructions included in the third signal.

3. The amusement vehicle of claim 1, wherein the transmitter is located near a front portion of the chassis and the receiver is located near a rear portion of the chassis.

4. The amusement vehicle of claim 1, wherein at least one of the first signal and the second signal is encoded to cause at least one of: accelerating the amusement vehicle, accelerating the at least another amusement vehicle, decelerating the amusement vehicle, decelerating the at least another amusement vehicle, stopping the at least another vehicle and side-slipping the at least another vehicle.

5. The amusement vehicle of claim 1, wherein the transmitter and the receiver respectively comprises a wireless transmitter and a wireless receiver.

6. The amusement vehicle of claim 5, wherein the wireless transmitter and the wireless receiver respectively transmit a directional signal selected from the group consisting of: infra-red and laser, or any combination thereof.

7. The amusement vehicle of claim 1, further comprising at least one of:
a user interface mounted on the chassis and operably connected to the controller for controlling the amusement vehicle and communication with the at least another amusement vehicle;
an indicator mounted on the chassis and operably connected to the controller for indicating to a driver of the amusement vehicle information about the first and second signals;
a speaker mounted on the chassis and operably connected to the controller for providing the driver of the amusement vehicle a sonar indication; and
a push button mounted on the chassis and operably connected to the controller for allowing the driver of the amusement vehicle to transmit the second signal to the at least another amusement vehicle.

8. The amusement vehicle of claim 7, wherein the indicator comprises at least one of: a light indicator, a sound indicator and a vibration indicator.

9. The amusement vehicle of claim 1, further comprising a speed controller mounted on the chassis and operably connected to the controller for controlling the speed of the vehicle in accordance with the instructions included in the first signal.

10. The amusement vehicle of claim 1, further comprising a communication system operatively connected to the controller for allowing a circuit operator to manage at least one of: the amusement environment and interactions between the amusement vehicle and the at least another amusement vehicle.

11. A kit for installing on an amusement vehicle having a chassis, a set of wheels and a motor the amusement vehicle for interacting with at least another amusement vehicle in an amusement environment, the kit comprising:
at least one of:
a receiver to be mounted on the chassis for receiving a first directional signal from the at least another amusement vehicle only when the at least another amusement vehicle is in substantial alignment with the receiver; and
a transmitter to be mounted on the chassis for transmitting a second directional signal to one of the at least another amusement vehicle in substantial alignment with the transmitter; and
a controller to be mounted on the chassis and to be at least one of: operably connected to the receiver and to be configured to decode the first signal for controlling the motor in accordance with instructions included in the first signal; and operably connected to the transmitter and to be configured to encode the second signal prior to sending it to the at least another amusement vehicle via the transmitter.

12. The kit of claim 11, further comprising at least one of a decelerating interacting element, an accelerating interacting element and a random interacting element to be positioned on the ground surface of the amusement environment.

13. The kit of claim 12, further comprising a signal sensor for receiving a third signal from the at least one of: the decelerating interacting element, the accelerating interacting element and the random interacting element positioned on the ground surface of the amusement environment in substantial alignment with the signal sensor, wherein the controller is to be operably connected to the signal sensor and configured to decode the third signal for controlling the motor in accordance with instructions included in the third signal.

14. The kit of claim 11, wherein at least one of the first signal and the second signal comprises at least one of: accelerating the amusement vehicle, accelerating the at least another amusement vehicle, decelerating the amusement vehicle, decelerating the at least another amusement vehicle, stopping the at least another vehicle and side-slipping the at least another vehicle.

15. The kit of claim 11, wherein the transmitter and the receiver respectively comprises a wireless transmitter and a wireless receiver.

16. The kit of claim 15, wherein the wireless transmitter and the wireless receiver respectively transmit and receive at least one of: infra-red signals and radio-frequency identification signals.

17. The kit of claim 11, further comprising at least one of:
a user interface to be mounted on the chassis and operably connected to the controller for controlling the amusement vehicle and communication with the at least another amusement vehicle;
an indicator to be mounted on the chassis and operably connected to the controller for indicating to a driver of the amusement vehicle information about the first and second signals;
a speaker to be mounted on the chassis and operably connected to the controller for providing the driver of the amusement vehicle a sonar indication; and
a push button to be mounted on the chassis and operably connected to the controller for allowing the driver of the amusement vehicle to transmit the second signal to the at least another amusement vehicle.

18. The kit of claim 11, further comprising a speed controller to mounted on the chassis and operably connected to the controller for controlling the speed of the vehicle in accordance with the instructions included in the first signal.

19. The kit of claim 11, further comprising a communication system to be operatively connected to the controller for allowing a circuit operator to manage at least one of: the amusement environment and interactions between the amusement vehicle and the at least another amusement vehicle.

20. An amusement vehicle for interacting with at least another amusement vehicle in an amusement environment, the amusement vehicle comprising:
a chassis;
a set of wheels for rotatably supporting the chassis on a ground surface;
a motor mounted on the chassis for propelling the chassis on the ground surface;
a controller operably connected to the motor for controlling the motor; and
a receiver located near a rear portion of the chassis for receiving a first wireless signal of the at least another amusement vehicle only when the at least another amusement vehicle is in substantial alignment with the receiver; and
a transmitter located near a front portion of the chassis for transmitting a second directional signal to one of the at least another amusement vehicle only when the at least another amusement vehicle is in substantial alignment with the transmitter;
the controller being at least one of: operably connected to the receiver and being configured to decode the first signal for controlling the motor in accordance with instructions included in the first signal; and operably connected to the transmitter and being configured to encode the second signal prior to sending it to the at least another amusement vehicle via the transmitter;
wherein the first signal and the second signal are directional signals and require substantial alignment between the amusement vehicles to be received.
